(19) United States
(12) Patent Application Publication
(10) Pub. No.: US 2016/0042660 A1
(43) Pub. Date: Feb. 11, 2016

(54) Process for Converting Actual Fitness Data into Nutritional Advice

(71) Applicant: Sergio Radovcic, Phoenix, AZ (US)

(72) Inventor: Sergio Radovcic, Phoenix, AZ (US)

(73) Assignee: NUTRIMATIX INC., Phoenix, AZ (US)

(21) Appl. No.: 14/823,837

(22) Filed: Aug. 11, 2015

Related U.S. Application Data
(60) Provisional application No. 62/035,621, filed on Aug. 11, 2014.

(51) Int. Cl. G09B 19/00; G09B 7/00

(52) U.S. Cl. CPC G09B 19/0092; G09B 7/00

(57) ABSTRACT

A method of ingesting and converging fitness data from one or multiple fitness activity trackers and providing personalized nutrition and supplemental recommendations, executed by a mobile device. The method comprises searching for one or more tracking devices, connecting to the tracking devices, and ingesting data from the tracking devices. The mobile device displays fitness questions based on the ingested data. The ingested data is processed to generate nutritional recommendations for the user, which are displayed on the mobile device.

### PRIORITY

This application claims the benefit of U.S. Provisional Application No. 62/035,621, filed Aug. 11, 2014.

### FIELD OF THE INVENTION

The present invention relates generally to fitness tracking and advice. In particular, the present invention relates to a process for ingesting and converging fitness data from one or multiple fitness activity trackers and providing personalized nutrition and supplement recommendations.

### BACKGROUND OF THE INVENTION

In this modern era, maintaining physical health and fitness is a common passion for people all over the world. Whether a person is dieting, running, lifting weights, or performing any activity towards improving their physical fitness, technology is a common tool to help optimize people's time and improve results. With over 200 million fitness activity trackers being used, people all over the world are able to create and track their fitness goals. Some examples of tracked activity include but are not limited to, distance traveled, heart rate, food eaten, and calories burned.

Currently, many products and mobile applications exist that track or dashboard people's fitness activity and provide little or no generalized feedback to the user on what they can do to improve their health and fitness goals. As well, these products work individually and do not aggregate the data to produce personalized recommendations. People have different needs based on their activity. Without proper data aggregation, feedback may be sparse or even detrimental to the user due to lurking variables unknown to the technology at hand. For example, it could be dangerous if a lactose intolerant person receives a recommendation to drink more milk as a source of protein and calcium. Even though some products provide some form of feedback or advice, they do not measure enough data points to produce an in depth and personalized response. Some of these products include but are not limited to running watchers, mobile phone apps, such as RunKeeper or Strava, or other activity trackers, such as FitBit or Jawbone. Forums are also a popular way of tracking physical fitness and health. These also allow the user to receive detailed feedback and recommendations. However, these responses are not always accurate or trustworthy. As well, it can take a significant amount of time to receive feedback.

It is therefore an objective of the present invention to introduce a method of data aggregation and ingestion combined with expert knowledge to produce personalized nutrition and supplementation recommendations, as well as non-recommendations (what not to take and do), explanations, and sources. It will provide quick, personalized, and accurate feedback not utilized in other fitness tracking technologies. This method will improve user's fitness and physical health through this new technology. This method will be driven by a complex mobile phone app and provide easy to access feedback.

### BRIEF DESCRIPTION OF THE DRAWINGS

FIG. 1 is flow diagram illustrating an exemplary basic high-level process flow of the method for converting actual fitness data into nutritional advice.

FIG. 2 is a flow diagram illustrating and exemplary detailed step-by-step process flow of the method for converting actual fitness data into nutritional advice.

FIG. 3 is a screenshot of a welcome screen of the present invention.

FIG. 4 is a screenshot of an answered question screen of the present invention.

FIG. 5 is a screenshot of a recommended supplement screen of the present invention.

FIG. 6 is a screenshot of a selecting gender, weight, and height screen of the present invention.

FIG. 7 is a screenshot of a lifestyle question screen of the present invention.

FIG. 8 is a screenshot of a vitamin information screen of the present invention.

FIG. 9 is another screenshot of a vitamin information screen of the present invention.

FIG. 10 is screenshot of information transmission to a physician of the present invention.

FIG. 11 is screenshot of a profile of the present invention.

### DETAILED DESCRIPTIONS OF THE INVENTION

All illustrations of the drawings are for the purpose of describing selected versions of the present invention and are not intended to limit the scope of the present invention.

The present invention is a method or process of ingesting fitness and exercise data from one or more devices on the market as inputs in order to output personalized user recommendations based on the inputs. These devices that produce data inputs include but are not limited to running watches, apps such as RunKeepr and Strava, stationary machines such as treadmills, and other 3^{rd} party activity trackers such as FitBit and Jawbone. The output recommendations include personalized nutritional recommendations, supplemental recommendations, reasoning behind the recommendations. A complex algorithm is utilized to take in the inputs and produce an appropriate output quickly and efficiently. Medical experts assisted with the creation of this to ensure high quality and accurate results. In the preferred embodiment of the present invention, this process will be driven from the use of a mobile app that can work on iPhones, Androids, or any other mobile device that can support the app.

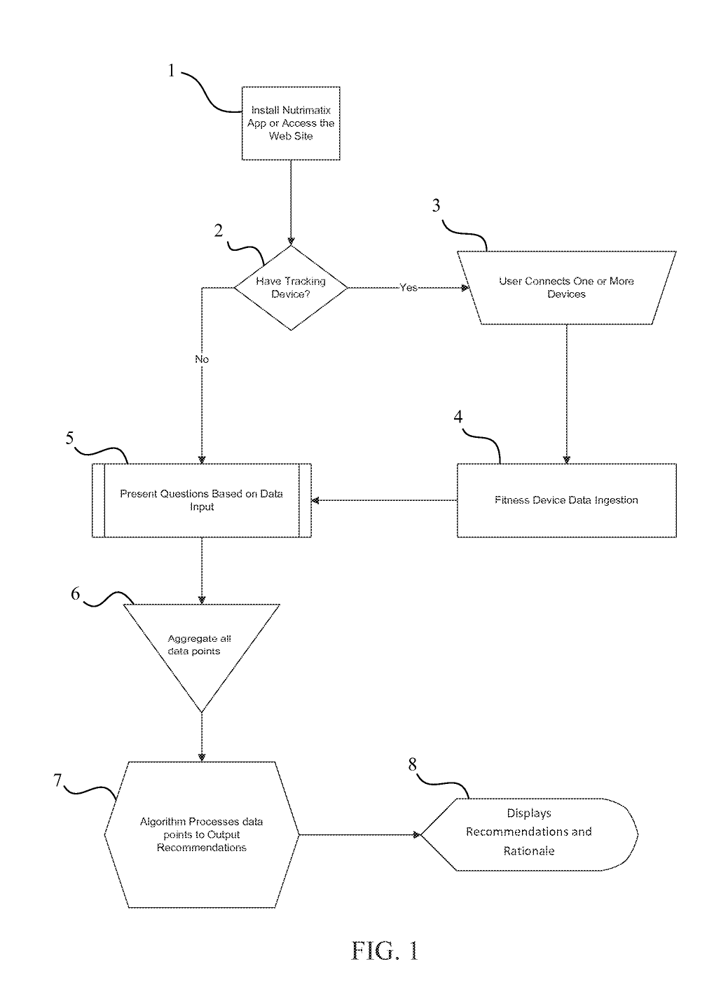

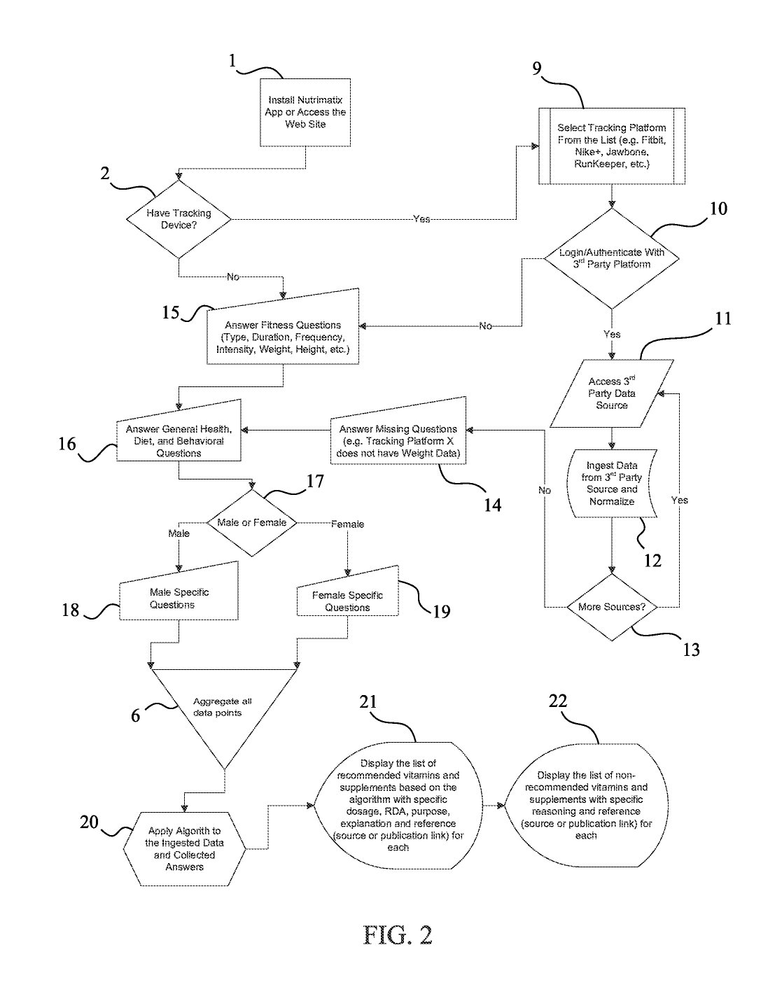

The preferred embodiment of the present invention comprises of a method. As illustrated in FIGS. 1-2, this method comprises installing the Nutrimatix App, selecting tracking devices, iterations for accessing, ingesting, and normalizing 3^{rd} party data as inputs, answers to fitness questions as data inputs, answers to general health, diet, and behavioral questions as data inputs, answers to gender specific questions as data inputs, data aggregation, an applied algorithm to ingested data inputs (collected answers and ingested 3^{rd} party data), displayed recommendations with explanations and references, and displayed non-recommendations with explanations and references.

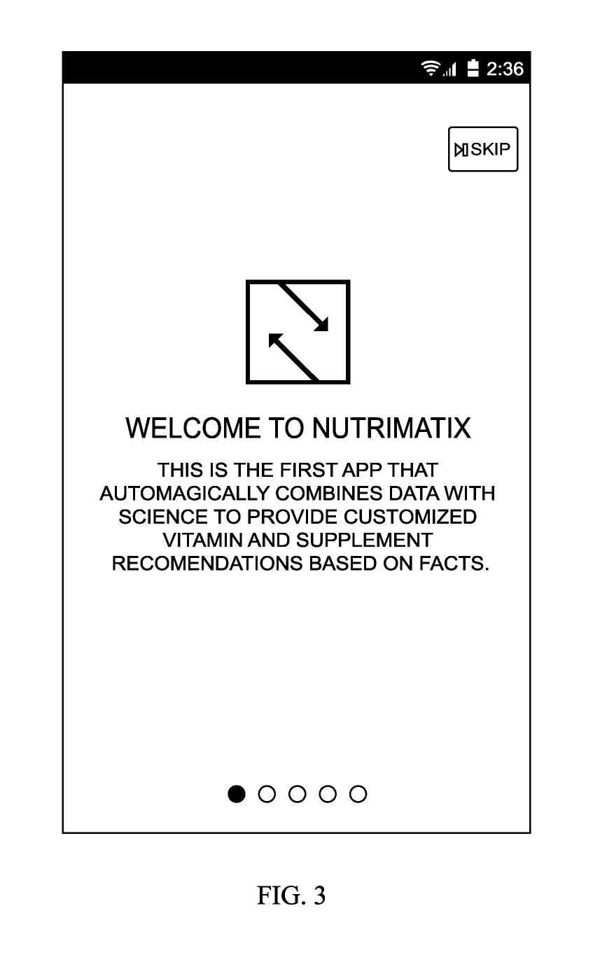

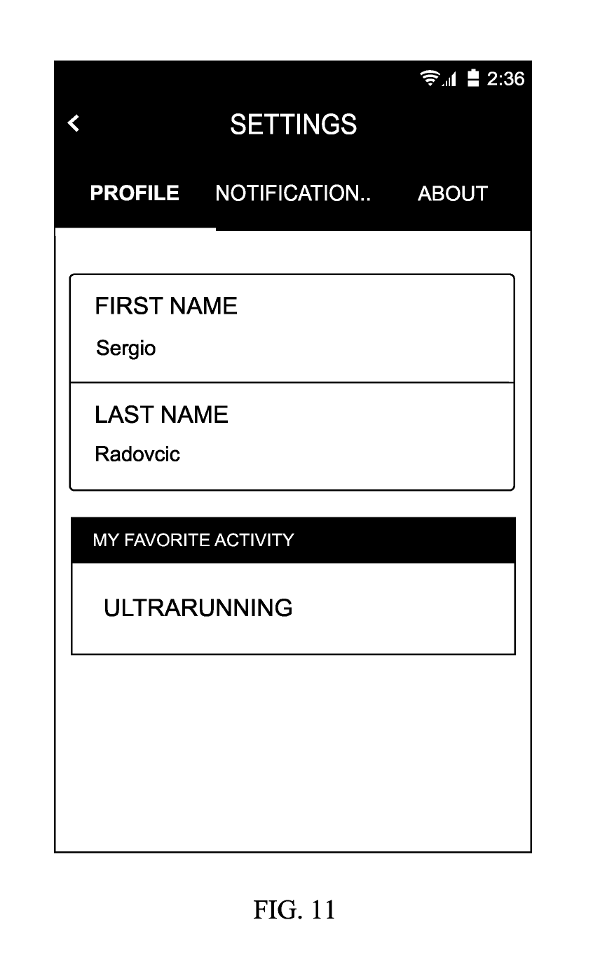

The logical flow utilized in the present invention to produce the appropriate output follows a specific methodology. First, the user must install the Nutrimatix App or access the website 1, as shown in FIGS. 2 and 3. When the Nutrimax App has been installed and opened, a welcome screen will be displayed as shown in FIG. 3. A user may then input a profile, as shown in FIG. 11. The welcome screen provides a brief description of the App. The logical systematic flow utilized in the method then will then make a decision based on whether or not the user has a fitness tracking device. Depending on the answer, the logical systematic flow path through the method will change.

In the current embodiment of the present invention, the user is asked if the user has any tracking device 2. If the answer is no, the user does not have any fitness tracking devices. From there, the user will answer fitness questions 15. These fitness questions include but are not limited to type of workout, duration, frequency, intensity, height, weight, location, longitude/latitude, amount of sunlight, etc. The answers to these fitness questions become data points. These data points become inputs to the algorithm used later in the method.

In the current embodiment of the present invention, if the answer is yes, then the user does have one or more fitness tracking devices. In this case, the user connects to the one or more devices 3. From there, the user selects the 3^{rd} party tracking platforms from the list 9 in the Nutrimatix system. In the preferred embodiment of the present invention, platforms the user chooses to include but are not limited to FitBit, Nike+, Jawbone, RunKeeper, etc. From there, the user must login/authenticate with a 3^{rd} party platform 10. If the user is unable to do this or wishes not to, the user will then be asked to answer the previously mentioned fitness questions 15. If the user does login/authenticate with a 3^{rd} party platform, 3^{rd} party source data will be accessed 11 by the user, then ingested and normalized 12 by the Nutrimatix system. Thus, a fitness device data ingestion 4 step has occurred. The data is normalized by reducing to steps and minutes of activity, since various devices may have different measurements (miles, nike fuel points, etc.).

The software will then determine if there are more sources 13. If necessary, the logic will then repeat itself. Based on the login/authentication of each 3^{rd} party platform, the Nutrimatix system will access the data from each 3^{rd} party source, then ingest and normalize it until there are no more sources left. Third party apps or devices are connected to via public APIs, which lets the user authenticate using their third-party credentials and obtain an access token. This token gives the app read-only permission to read activity data as needed. The accessed, ingested, normalized 3^{rd} party data is used to fill in the answers to any missing fitness questions 14. The user will then be asked to fill in any general health, diet, and behavioral questions 16 that the 3^{rd} party data was unable to cover. For example, the 3^{rd} party data may not have the user's height or weight information, thus, the user will then be asked to fill out information or answer questions regarding such data.

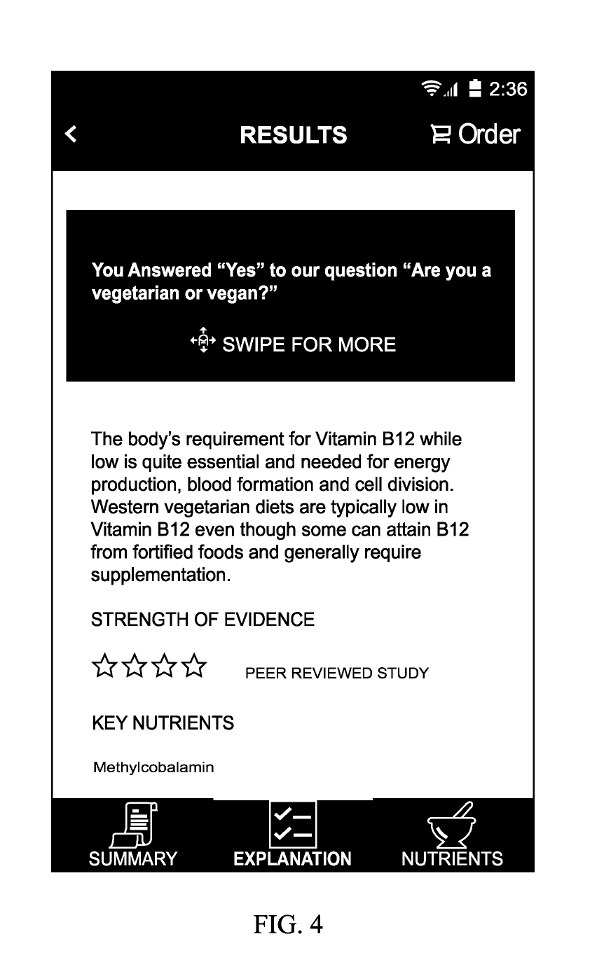

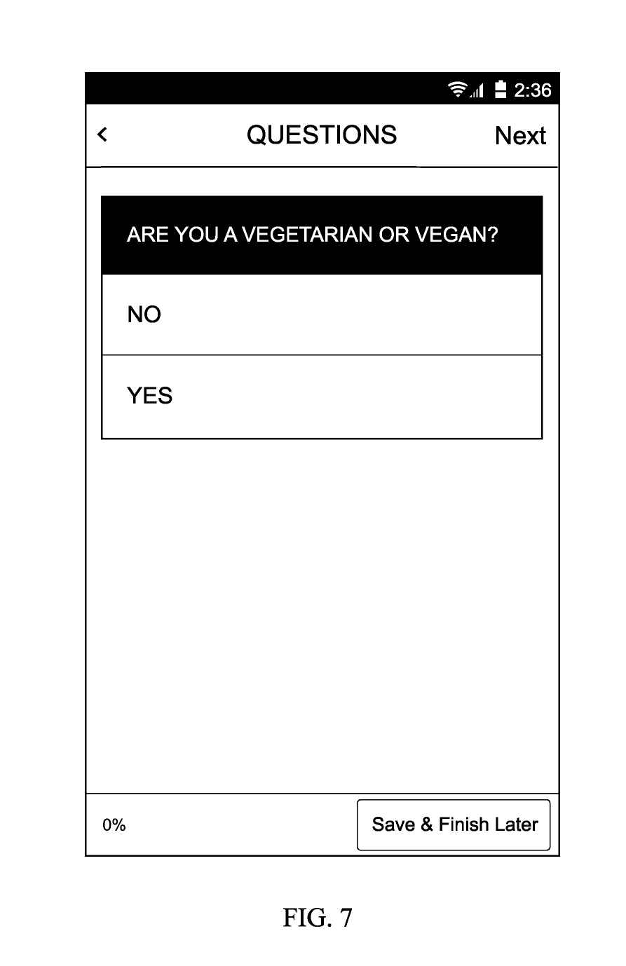

In the preferred embodiment of the present invention, after the fitness questions have been answered, general health, diet, and behavior questions will then be asked. The software presents questions based on data input 5. Whether or not the user has a tracking device, the general health, diet, and behavior questions will be asked following the fitness questions. In the preferred embodiment of the invention, general health, diet, and behavior questions asked about, include but are not limited to type of food/beverage consumption, quantity, frequency, allergies, ailments, smoking, drug use, etc. The answers to these questions become data points. These data points are used as inputs to the algorithm used later in this method. One example of a general health, diet, and behavior question is shown in FIG. 7, in which the user is asked if they are a vegetarian or vegan. An example of an answer to a typical general health, diet, and behavior question is shown in FIG. 4. In this screenshot, the user is asked if they are a vegetarian or a vegan.

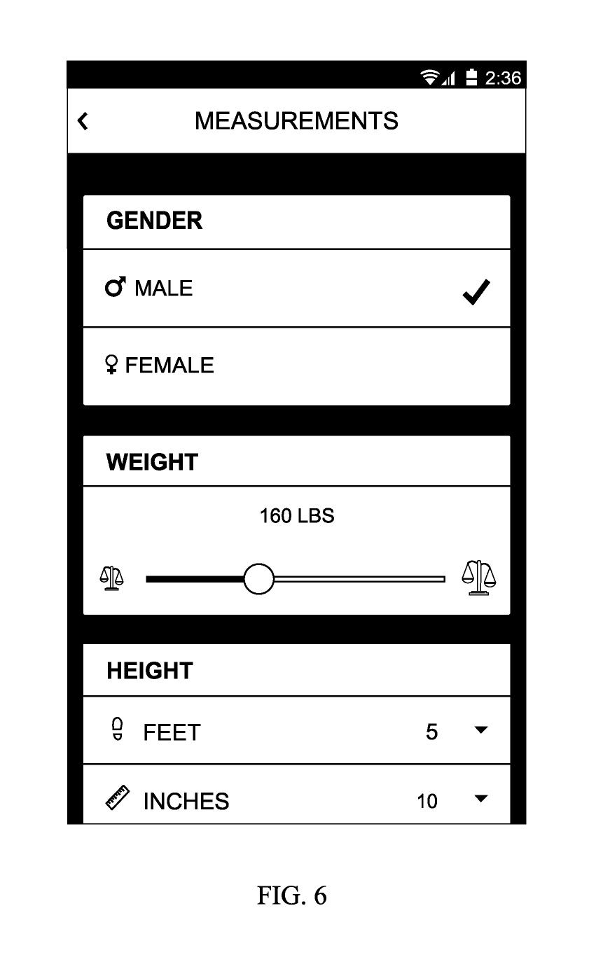

In the preferred embodiment of the present invention, once the general health, diet, and behavior questions have been answered, the user will then be asked gender specific questions based on whether they are male or female 17. A screenshot of that allows the user to select a gender is shown in FIG. 6. Males will be asked male specific questions 18, while females will be asked female specific questions 19. For example, a female specific question may include but is not limited to being asked about menstrual cycles or pregnancy, while a male specific question may include but is not limited to being asked about their prostate health. The questions and answers in the preferred embodiment of the invention are not intended to limit its scope or objective.

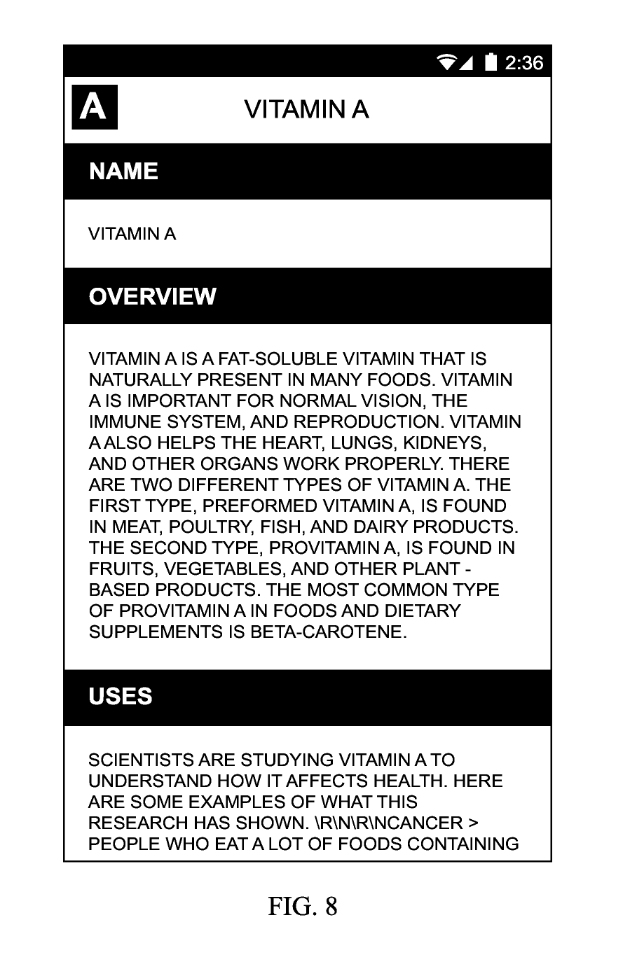

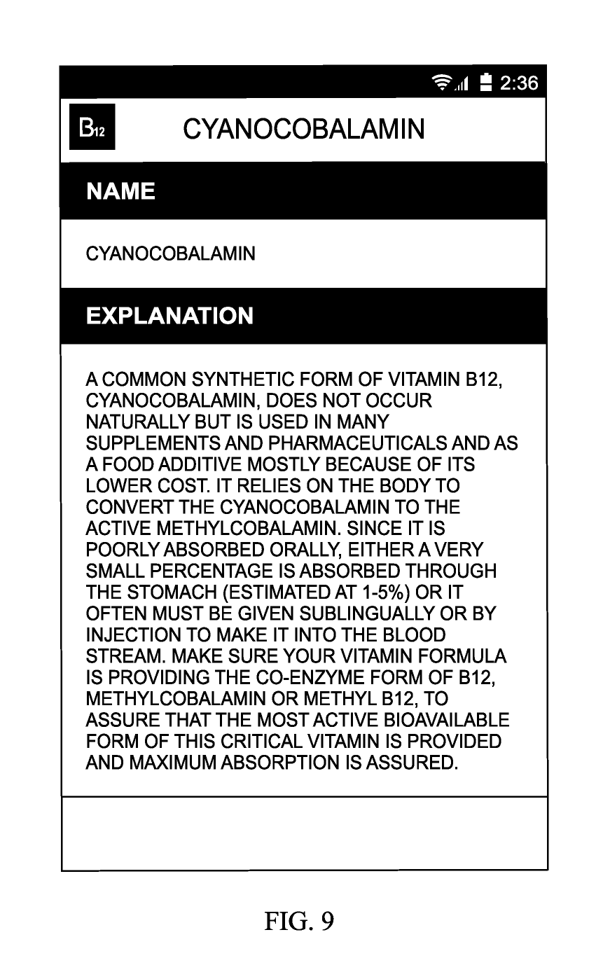

In the preferred embodiment of the present invention, with the gender specific questions answered, the method then aggregates all the data points 6. These data points may include but are not limited to answers to fitness questions, answers to general health, diet, and behavioral questions, gender specific questions, and any additional useable data ingested from the 3^{rd} party data sources. These data points will be used as inputs that are applied to an algorithm 20. From there, the algorithm processes data points to output recommendations 7. These outputs are then displayed to the user. The algorithm displays recommendations and rationale 8. A list is displayed comprising recommended vitamins, nutrients (macro and micro), and supplements based on the algorithm with specific dosages, RDA (recommended dietary allowances), their purpose, an explanation, and references (source, publication link, etc) for each 21. For example, 2,500 UI of Vitamin C may be recommended, along with detailed reasoning for the recommendation, any counter indications, and sources for the recommendation. In one embodiment, the algorithm comprises accessing a database containing possible responses and recommendations based on each response. Each vitamin may also be provided with an overview and uses, as shown in FIGS. 8 and 9. Following this, another list will be displayed comprising of non-recommended vitamins and supplements with specific reasoning and references (source, publication link, etc) for each 22.

Frequency data, intensity data, duration data, recovery between events data and location (indoor/outdoor) data have been captured through the data ingestion and questions. The final combination of activity and answers places the consumer into a “band” which would correspond to a specific mix of vitamins, minerals and trace elements.

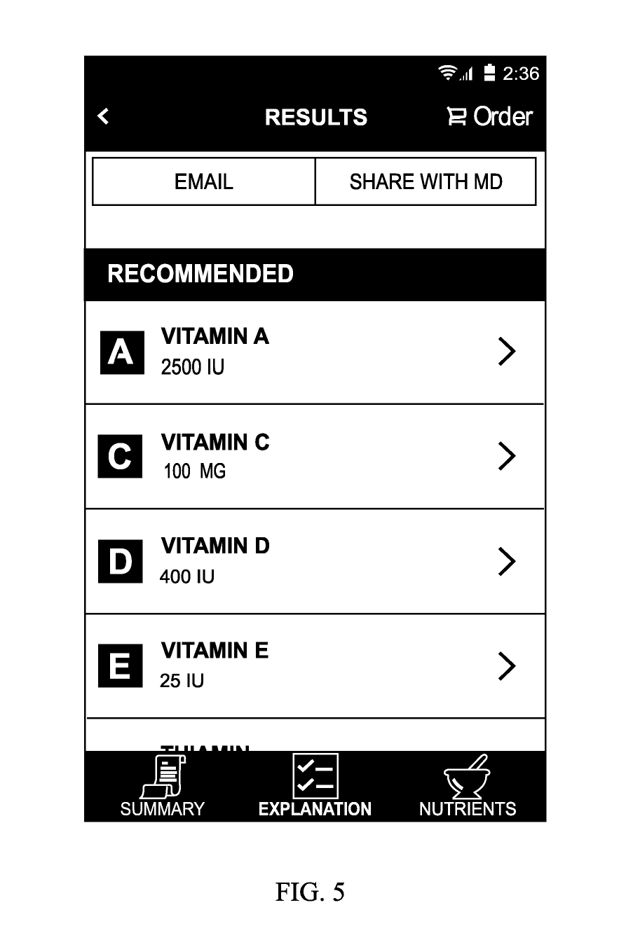

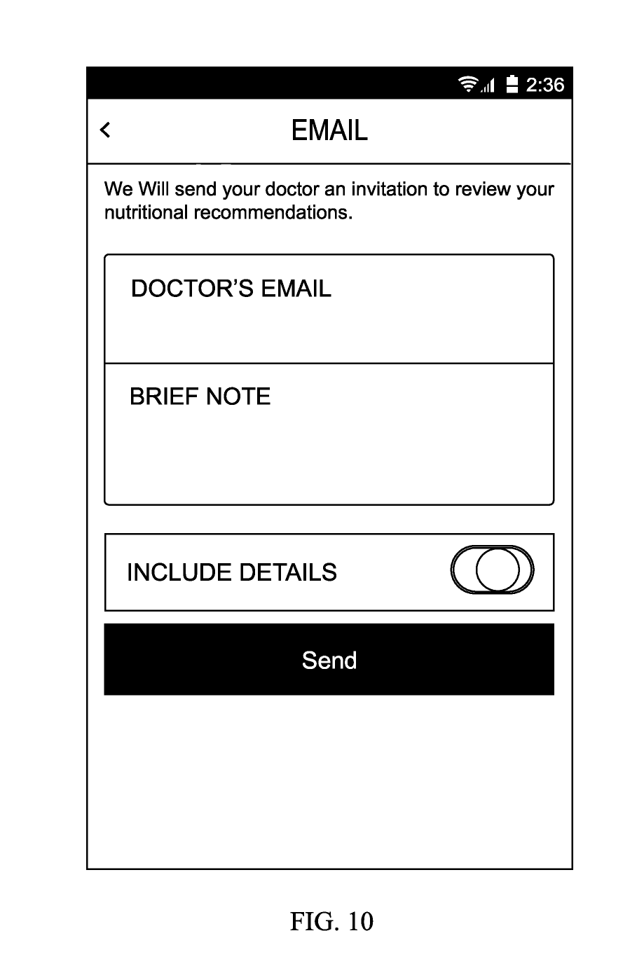

In the preferred embodiment of the present invention, the displayed recommendations and non-recommendations will be comprised of an explanation and reference for each piece of supporting information. In FIG. 5, a list of vitamin recommendations is provided. These references will also be given ratings depending on the strength of the evidence. These references will be given a rating between one and five, with one being the lowest and five being the highest score. For example, a published article that is referenced will be given a rating of one, a published study (not an article) will be given a three, and a peer review double blind study will be given a five. These ratings are not meant to limit the scope or objective of the preferred or any other embodiments of the present invention. Upon request by the user, the recommendations can be sent to a doctor or other recipient by email, along with a brief note, as shown in FIG. 10.

In other embodiments of the present invention, the order in which the method executes its functions may change. For example, in one embodiment, general health, diet, and behavioral questions may be asked before the fitness questions. The sequences in which questions are asked, as well as the contents of the questions are not meant to limit the scope or objective of the invention.

Although the invention has been explained in relation to its preferred embodiment, it is to be understood that many other possible modifications and variations can be made without departing from the spirit of the scope of the invention.

1. A method of ingesting fitness data and outputting personalized user recommendations, executed by a mobile computing device, comprising:
searching for one or more tracking devices;
if the one or more tracking devices are present, connecting to the one or more tracking devices and ingest fitness data from the one or more tracking devices;
displaying fitness questions, the fitness questions based on the fitness data if present;
receiving fitness information from a user based on the fitness questions;
displaying general questions, the general questions comprising health, diet, and behavior questions;
receiving general information from the user based on the general questions;
aggregating data points of the fitness data, fitness information, and general information;
processing the fitness data, fitness information, and general information to generate output recommendations; and
displaying recommendations and rationale for the recommendations.

2. The method of claim 1, wherein the fitness questions comprise type of workout, duration, frequency, intensity, height, weight, location, longitude, latitude, and amount of sunlight.

3. The method of claim 1, wherein the general questions comprise food consumption, beverage consumption, quantity of consumption, frequency of consumption, allergies, smoking, and drug use.

4. The method of claim 1, wherein the male specific questions comprise prostate health questions.

5. The method of claim 1, wherein the female specific questions comprise menstrual cycle and pregnancy questions.

6. A method of ingesting fitness data and outputting personalized user recommendations, executed by a mobile computing device, comprising:
searching for a tracking device;
prompting a user to select tracking platforms from a list of tracking platforms;
prompting the user to authenticate each selected tracking platform, if at least one tracking platform was selected;
if no tracking platforms are selected or no authentication is provided, prompting the user to answer fitness questions and general questions, the general questions comprising health, diet, and behavior questions;
if authentication is provided, accessing third party data sources from each selected tracking platform, ingesting fitness data from each of the selected tracking platforms, and prompting a user to provide relevant information not obtained by the selected tracking platforms;
prompting the user to input gender;
if the user inputs “male”, prompting the user to answer male specific questions;
if the user inputs “female”, prompting the user to answer female specific questions;
aggregating collected data comprising the fitness data and user information;
applying an algorithm to the fitness data and user information;
displaying a first list of recommended vitamins, nutrients, and supplements based on the algorithm; and
displaying a second list of non-recommended vitamins, nutrients, and supplements based on the algorithm.

7. The method of claim 6, wherein the fitness questions comprise type of workout, duration, frequency, intensity, height, weight, location, longitude, latitude, and amount of sunlight.

8. The method of claim 6, wherein the general questions comprise food consumption, beverage consumption, quantity of consumption, frequency of consumption, allergies, smoking, and drug use.

9. The method of claim 6, wherein the male specific questions comprise prostate health questions.

10. The method of claim 6, wherein the female specific questions comprise menstrual and pregnancy questions.

11. The method of claim 6, wherein the first list comprises specific dosages, recommended dietary allowances, purposes, explanations, and references.

12. The method of claim 11, wherein the first list further comprises ratings of strength of evidence of the references.

13. The method of claim 6, wherein the second list comprises specific reasoning and references.

14. The method of claim 13, wherein the second list further comprises rating of strength of evidence of the references.
